(19) United States
(12) Patent Application Publication
(10) Pub. No.: US 2026/0236706 A1
(43) Pub. Date: Aug. 13, 2026

(54) QUESTION ANSWERING METHOD AND QUESTION ANSWERING MODEL TRAINING METHOD

(71) Applicant: ALIBABA INNOVATION PRIVATE LIMITED, Singapore (SG)

(72) Inventors: Binyuan HUI, Beijing (CN); Yunshui LI, Beijing (CN); Fei HUANG, Sunnyvale, CA (US); Yongbin LI, Beijing (CN)

(21) Appl. No.: 19/151,295

(22) PCT Filed: Mar. 29, 2024
(86) PCT No.: PCT/SG2024/050201

§ 371 Date: Jul. 25, 2025

(30) Foreign Application Priority Data
Apr. 11, 2023 (CN) 202310412430.3

(51) Int. Cl. G06F 40/35; G06N 20/00; G06V 10/774; G06V 10/776

(52) U.S. Cl. CPC G06F 40/35; G06N 20/00; G06V 10/774; G06V 10/776

(57) ABSTRACT

Embodiments of the present disclosure provide a question answering method and a question answering model training method. The question answering method includes that: question information to be answered is obtained; and the question information is inputted into a question answering model, to obtain answer information corresponding to the question information. The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model.

### CROSS-REFERENCE TO RELATED APPLICATIONS

The present disclosure claims priority of Chinese Patent Application No. 202310412430.3, filed to China National Intellectual Property Administration on Apr. 11, 2023 and titled “QUESTION ANSWERING METHOD AND QUESTION ANSWERING MODEL TRAINING METHOD”, the content of which is hereby incorporated by reference in its entirety.

### TECHNICAL FIELD

Embodiments of the present disclosure relate to the field of computer technologies, and in particular, to a question answering method.

### BACKGROUND OF THE INVENTION

With enriching of multimedia data, a task-based dialog system has attracted widespread attention. For example, for an intelligent customer service in the e-commerce field, the task-based dialog system can enable a user to independently obtain a response to a question of the user. With increasing requirements of users on the task-based dialog system, the dialog system needs to first determine a modality of a response to a user, to be specific, whether to respond with an image or text, and then complete response to content. However, since multi-modality dialog data is difficult to be collected, there is less training data, and a dialog generation model is difficult to be trained, resulting in a poor application effect of the dialog generation model.

### SUMMARY OF THE INVENTION

In view of this, embodiments of the present disclosure provide a question answering method. At least one embodiment of the present disclosure also relates to another question answering method, a question answering model training method, a textual question answering method, a question answering apparatus, a computing device, a computer-readable storage medium, and a computer program, to resolve technical defects in the related art.

According to a first aspect of embodiments of the present disclosure, a question answering method is provided, including the following steps.

Question information to be answered is obtained.

The question information is inputted into a question answering model, to obtain answer information corresponding to the question information.

The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model. The target semantic information is generated based on an image description text corresponding to the image to be trained and a dialog text associated with the image to be trained.

According to a second aspect of embodiments of the present disclosure, another question answering method is provided, applied to a cloud side device, and including the following steps.

A question answering request sent by a terminal side device is received, where the question answering request carries question information.

The question information is inputted into a question answering model, to obtain answer information corresponding to the question information.

The question answering model is trained based on predicted answer information, the predicted answer information is obtained by predicting, by using a pre-trained question answering model, answer information corresponding to a question sample, the pre-trained question answering model is trained based on a predicted image-text matching result, the predicted image-text matching result is obtained by matching an image to be trained with target semantic information using the pre-trained question answering model, and the target semantic information is generated based on an image description text corresponding to the image to be trained and a dialog text associated with the image to be trained.

The answer information is sent to the terminal side device.

According to a third aspect of embodiments of the present disclosure, a question answering model training method is provided, applied to a cloud side device, and including the following steps.

A pre-training sample is obtained, where the pre-training sample includes an image to be trained, an image description text corresponding to the image to be trained, and a dialog text associated with the image to be trained.

The pre-trained question answering model is trained based on a predicted image-text matching result corresponding to the pre-training sample, where the predicted image-text matching result is obtained by matching the image to be trained with target semantic information using the pre-trained question answering model, and the target semantic information is generated based on the image description text and the dialog text.

A question sample is obtained, where the question sample includes an image to be trained and dialog text associated with the image to be trained.

The question sample is inputted into the pre-trained question answering model, to output the predicted answer information, and the pre-trained question answering model is trained based on the predicted answer information, to obtain a question answering model.

Model parameters of the question answering model are sent to a terminal side device.

According to a fourth aspect of embodiments of the present disclosure, a textual question answering method is provided, applied to a terminal side device, and including the following steps.

Textual question information is received.

The textual question information is inputted into a question answering model, to obtain textual answer information corresponding to the textual question information, where the question answering model is obtained according to the question answering model training method.

The textual answer information is displayed.

According to a fifth aspect of embodiments of the present disclosure, a question answering apparatus is provided, including:
a question obtaining module, configured to obtain question information to be answered; and
an answer obtaining module, configured to input the question information into a question answering model, to obtain answer information corresponding to the question information. The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model. The target semantic information is generated based on an image description text corresponding to the image to be trained and a dialog text associated with the image to be trained.

According to a sixth aspect of embodiments of the present disclosure, a computing device is provided, including:
a memory and a processor.

The memory is configured to store computer-executable instructions, the processor is configured to execute the computer-executable instructions, and when the computer-executable instructions are executed by the processor, the steps in the foregoing method are implemented.

According to a seventh aspect of embodiments of the present disclosure, a computer-readable storage medium is provided, storing computer-executable instructions. When the instructions are executed by a processor, the steps in the foregoing method are implemented.

According to an eighth aspect of embodiments of the present disclosure, a computer program is provided. When the computer program is executed on a computer, the computer is enabled to perform the steps in the foregoing method.

According to the question answering method provided in some embodiments of the present disclosure, the question information to be answered is obtained, and the question information is inputted into the question answering model, to obtain the answer information corresponding to the question information. The question answering model is trained based on the predicted answer information. The predicted answer information is obtained by predicting, by using the pre-trained question answering model, the answer information corresponding to the question sample. The pre-trained question answering model is trained based on the predicted image-text matching result. The predicted image-text matching result is obtained by matching the image to be trained with the target semantic information using the pre-trained question answering model. The target semantic information is generated based on the image description text corresponding to the image to be trained and the dialog text associated with the image to be trained.

In the embodiments of the present disclosure, the question information to be answered is inputted into the question answering model, to obtain the answer information output by the question answering model. The question answering model is obtained by training the pre-trained question answering model. The answer information corresponding to the question sample is predicted by using the pre-trained question answering model, and the question answering model is trained based on the predicted answer information. In addition, the pre-trained question answering model is trained based on the predicted image-text matching result, and the predicted image-text matching result is obtained by matching the image to be trained with the target semantic information by the pre-trained question answering model. In addition, the target semantic information is generated based on the image description text corresponding to the image to be trained and the dialog text associated with the image to be trained. In this manner, an objective of training the question answering model to better learn target semantic text by using a limited amount of dialog texts and images to be trained, so that the question answering model can be trained to output dialog content based on the dialog text. In this way, a large amount of dialog texts does not need to be used as training data, and the question answering model can better learn semantic knowledge in the dialog texts, so that answer information of the trained question answering model is more accurate, thereby improving an application effect of the model.

### BRIEF DESCRIPTION OF DRAWINGS

FIG. 1 is a schematic diagram of an application scenario of a question answering method according to some embodiments of the present disclosure.

FIG. 2 is a flowchart of a question answering method according to some embodiments of the present disclosure.

FIG. 3a is a schematic diagram of first-stage training of a question answering model in a question answering method according to some embodiments of the present disclosure.

FIG. 3b is a schematic diagram of second-stage training of a question answering model in a question answering method according to some embodiments of the present disclosure.

FIG. 3c is a schematic diagram of third-stage training of a question answering model in a question answering method according to some embodiments of the present disclosure.

FIG. 4 is a flowchart of another question answering method according to some embodiments of the present disclosure.

FIG. 5 is a flowchart of a question answering model training method according to some embodiments of the present disclosure.

FIG. 6 is a flowchart of a textual question answering method according to some embodiments of the present disclosure.

FIG. 7 is a structural schematic diagram of a question answering apparatus according to some embodiments of the present disclosure.

FIG. 8 is a structural block diagram of a computing device according to some embodiments of the present disclosure.

### DETAILED DESCRIPTION OF THE INVENTION

In the following descriptions, numerous specific details are described to provide a thorough understanding of the present disclosure. However, the present disclosure can be implemented in many other manners different from those described herein, and a person having ordinary skill in the art can make similar promotion without violating the connotation of the present disclosure. Therefore, the present disclosure is not limited to specific implementations disclosed below.

The terms used in at least one embodiment of the present disclosure are for the purpose of describing specific embodiments, and are not intended to limit the at least one embodiment of the present disclosure. The terms “a”, “the”, and “this” of singular forms used in at least one embodiment and the appended claims of the present disclosure are also intended to include plural forms, unless otherwise specified in the context clearly. It should also be understood that the term “and/or” used in at least one embodiment of the present disclosure means and includes any or all possible combinations of at least one associated listed item.

It should be understood that although the terms such as first and second are used for describing various information in at least one embodiment of the present disclosure, such information should not be limited to these terms. These terms are used for distinguishing information in a same type from each another. For example, without departing from the scope of at least one embodiment of the present disclosure, first may also be referred to as second, and similarly, second may also be referred to as first. Depending on the context, for example, the term “if” used herein is interpreted as “while”, “when”, or “in response to determining”.

In addition, it should be noted that user information (including but not limited to user equipment information, user personal information, and the like) and data (including but not limited to data for analysis, stored data, displayed data, and the like) in at least one embodiment of the present disclosure are both information and data that are authorized by a user or that are sufficiently authorized by all parties, and related data needs to be collected, used, and processed by complying with related laws and regulations and standards of related countries and regions, and a corresponding operation entry is provided for a user to select authorization or rejection.

First, terms in at least one embodiment of the present disclosure are explained.

Multi-modality: In the field of artificial intelligence, the multi-modality usually means perceptive information, such as an image, a text, and a voice.

With enriching of multimedia data, dialog communication on the Internet is no longer limited to a text-only mode. Therefore, an introduction of a multi-modality dialog may become an unstoppable trend for future intelligent customer services. The multi-modality dialog requires a model to first determine a modality of a response to a user, to be specific, whether to respond with an image or text. Secondly, the model needs to retrieve a contextually appropriate response, including image retrieval and text retrieval. In addition, the model needs to have a capability of tracking a user status, to track a user requirement. Finally, the model needs to have a text generation capability, to generate a smooth and natural response. However, in today's data-driven landscape, multi-modality dialog data is not well collected due to a series of problems such as privacy, so that a limited amount of dialog data makes model training difficult. In contrast, multi-modality non-dialog data has a large scale. Therefore, embodiments of the present disclosure provide an incremental mixture-of-experts based multi-modality dialog pre-training model, which uses recognition and matching capabilities of text experts and image experts to model a multi-modality non-dialog data model, and inherits the foregoing expert capabilities to introduce multi-modality dialog data to model dialog experts, so as to enhance a model capability step by step.

In the present disclosure, a question answering method is provided. The present disclosure further relates to another question answering method, a question answering model training method, a textual question answering method, a question answering apparatus, a computing device, and a computer-readable storage medium. Detailed descriptions are provided one by one in the following embodiments.

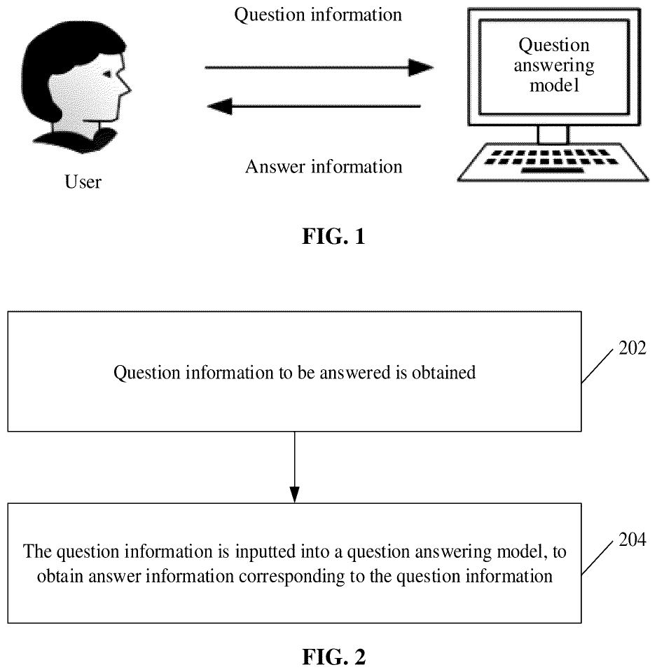

FIG. 1 is a schematic diagram of an application scenario of a question answering method according to some embodiments of the present disclosure.

It should be noted that the question answering method provided in the embodiments is applied to a question-answer response scenario of an intelligent customer service, and the like. A specific application scenario may adapt to different requirements based on different item requirements. This is not limited in the embodiments. For ease of understanding, in the embodiments, an application scenario in which a user interacts with an intelligent customer service is used as an example for description.

During actual application, the user sends question information to be answered to the intelligent customer service. The question information is understood as information in different application scenarios, and includes but is not limited to text information, image information, and the like. Since the intelligent customer service uses a question answering model in the question answering method provided in some embodiments, after receiving the question information sent by the user, the question answering model outputs answer information corresponding to the question information. The answer information is understood as answer content fed back for the question information, and includes but is not limited to text information, image information, and the like. Further, the user receives the answer content fed back by the intelligent customer service. It should be noted that, before the question answering model is put into use, the question answering model needs to be pre-trained. Specifically, in some embodiments, the model is trained in a staged training manner and different expert networks are combined to train the question answering model better. The question answering model is modeled by introducing multi-modality dialog data, to enhance a model capability step by step.

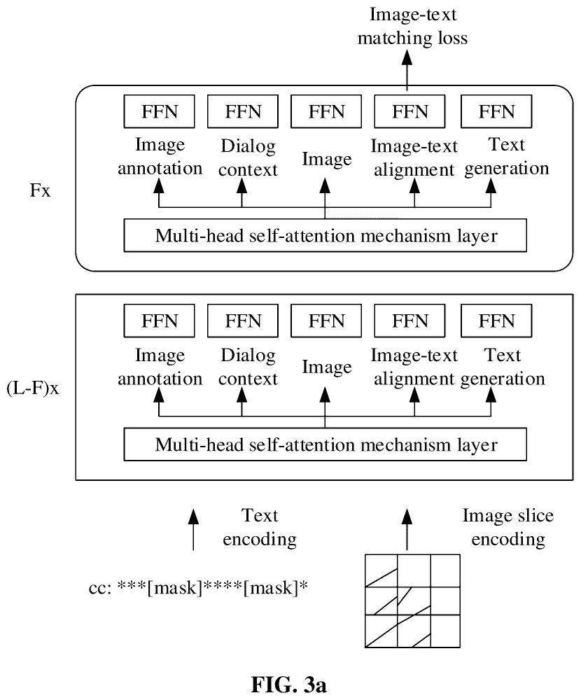

FIG. 2 is a flowchart of a question answering method according to some embodiments of the present disclosure. The method specifically includes the following steps.

In step 202, question information to be answered is obtained.

During actual application, an executed object obtains the question information to be answered. The question information is understood as question content that the user needs to wait for an answer, and includes but is not limited to text content, image content, text and image content, and the like.

In step 204, the question information is inputted into a question answering model, to obtain answer information corresponding to the question information.

The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model. The target semantic information is generated based on an image description text corresponding to the image to be trained and a dialog text associated with the image to be trained.

During actual application, the executed object inputs the question information into the question answering model, to obtain the answer information corresponding to the question information. The answer information is understood as answer content corresponding to the question information, and includes at least one of text content and image content, and the like. It should be noted that the question answering model provided in the embodiments is obtained by training the pre-trained question answering model, and is trained based on the predicted answer information output by the pre-trained question answering model based on the question sample. Further, the pre-trained question answering model is alternatively trained based on the image to be trained and the target semantic information. The target semantic information is generated based on the image description text corresponding to the image to be trained and the dialog text associated with the image to be trained.

For ease of understanding, a training process of the question answering model is described in the following embodiments. The training process of the question answering model includes three stages of training. To be specific, first, an initial question answering model at a first stage is trained based on an image and an image annotation text. Then, a pre-trained question answering model at a second stage is trained based on an image, an image annotation text, and a dialog text. Finally, a question answering model at a third stage is trained based on an image and a dialog text. It should be noted that the initial question answering model, the pre-trained question answering model, and the question answering model are all the same question answering model. This is understood as that at different training stages, output capabilities and effects of the question answering model are different. In the training process provided in the embodiments, first, the pre-trained question answering model is trained, and then the question answering model is trained. This is a training process at the second stage and the third stage. Specifically, before inputting the question information into the question answering model, to obtain the answer information corresponding to the question information, the method further includes the following steps.

A pre-training sample is obtained, where the pre-training sample includes an image to be trained, an image description text corresponding to the image to be trained, and a dialog text associated with the image to be trained;

The pre-trained question answering model is trained based on the predicted image-text matching result corresponding to the pre-training sample, where the predicted image-text matching result is obtained by matching the image to be trained with the target semantic information by the pre-trained question answering model, and the target semantic information is generated based on the image description text and the dialog text.

A question sample is obtained, where the question sample includes an image to be trained and the dialog text associated with the image to be trained.

The question sample is inputted into the pre-trained question answering model, to output the predicted answer information, and the pre-trained question answering model is trained based on the predicted answer information, to obtain the question answering model.

The pre-training sample is understood as sample data for training the pre-trained question answering model, and includes the image to be trained, the image description text corresponding to the image to be trained, and the dialog text associated with the image to be trained. The image to be trained is understood as any type of training image, and an image type is not limited. The image description text corresponding to the image to be trained is understood as text information that describes image content in the image to be trained, for example, describes object content and a state in the image. The dialog text associated with the image to be trained is understood as dialog information related to the image to be trained. The dialog information is understood as dialog data between different entities, and a form of dialog content and a dialog entity are not limited in the embodiments.

During actual application, the pre-trained question answering model is trained based on the predicted image-text matching result corresponding to the pre-training sample. The predicted image-text matching result is obtained by matching the image to be trained with the target semantic information based on an information matching layer (FFN) in the pre-trained question answering model. It should be noted that the target semantic information is understood as being obtained through vector matching between the image description text and the dialog text. In other words, this is understood as that the pre-trained question answering model can better understand semantic information in the dialog text based on the image description text. Further, after training of the pre-trained question answering model is completed, the question sample is further obtained. The question sample is understood as a training sample used in the question answering model, including the image to be trained and the dialog text associated with the image to be trained. The question sample is inputted into the pre-trained question answering model, to obtain the predicted answer information output by an information generation module in the pre-trained question answering model. Then, the pre-trained question answering model is continued to be trained based on the predicted answer information. Finally, the better-trained question answering model is obtained.

In the embodiments, in a manner of training the question answering model, the pre-trained question answering model is trained first, and then the pre-trained question answering model is continued to be trained at a next stage, so that the question answering model can have a step-by-step learning capability.

Further, at the third stage of training the question answering model, the question answering model is trained based on the predicted answer information output by the pre-trained question answering model. In some embodiments, model training is performed in an autoregressive manner. Specifically, an operation of training the pre-trained question answering model based on the predicted answer information, to obtain the question answering model includes the following steps.

An autoregressive loss value is calculated based on the predicted answer information.

The pre-trained question answering model is trained based on the autoregressive loss value, to obtain the question answering model.

During actual application, the executed object calculates the autoregressive loss value based on the predicted answer information output by the pre-trained question answering model, and trains the pre-trained question answering model based on the autoregressive loss value, to obtain the question answering model. In the embodiments, for determining the autoregressive loss value, refer to the following Formula 1:

$${ℒ}_{stage}^{III} = - {\sum }_{n = 1}^{N} log {p}_{rgm} ( {C}_{n} \vert V , {C}_{< n} ) \qquad Formula 1$$

$${ℒ}_{stage}^{III}$$

indicates a loss value at the third stage, C indicates a dialog history, V indicates an image, and p* indicates a model prediction result.

Further, for the stage of training the pre-trained question answering model, that is, the second stage, the model needs to learn a matching capability between an image and a dialog text, and an image-text alignment layer (FFN) in the pre-trained question answering model further needs to be trained. Specifically, an operation of training the pre-trained question answering model based on the predicted image-text matching result corresponding to the pre-training sample includes the following steps.

For the image to be trained in the pre-training sample, image processing is performed on the image to be trained by using the pre-trained question answering model, to obtain an image vector.

For the dialog text in the pre-training sample and associated with the image to be trained, text processing is performed on the dialog text by using the pre-trained question answering model, to obtain a dialog vector.

The predicted image-text matching result is generated based on the image vector and the dialog vector.

An image-text alignment loss value is determined based on the predicted image-text matching result, and the pre-trained question answering model is trained based on the image-text alignment loss value.

During actual application, at the stage of training the pre-trained question answering model, the image to be trained in the pre-training sample is input into an image processing layer (FFN) in the pre-trained question answering model, to obtain the image vector. Then, the dialog text in the pre-training sample and associated with the image to be trained is inputted into a dialog processing layer (FFN) in the pre-trained question answering model, to obtain the dialog vector. After vector processing is separately performed on the image and the text, matching is performed based on the image vector and the dialog vector, to generate the predicted image-text matching result, a loss value of the image-text alignment layer (FFN) is determined based on the predicted image-text matching result, and the pre-trained question answering model is trained based on the loss value.

In this manner, the model learns matching information between the image and the dialog text by using multi-modality data of the image and the dialog, so that the pre-trained question answering model has a capability of matching an image with a dialog.

Further, at the stage of training the pre-trained question answering model, to train the pre-trained question answering model better, in addition to performing training based on the image-text alignment loss value, reference is further made to a loss value corresponding to the image to be trained and a loss value corresponding to the dialog text. Specifically, an operation of training the pre-trained question answering model based on the image-text alignment loss value includes the following steps.

A dialog annotation alignment loss value is calculated based on the image vector, and calculating an image dialog loss value based on the dialog vector.

The pre-trained question answering model is trained based on the dialog annotation alignment loss value, the image dialog loss value, and the image-text alignment loss value.

During actual application, the executed object further calculates the dialog annotation alignment loss value corresponding to the image vector obtained through encoding the image to be trained by an image processing module. Further, a corresponding image dialog loss value is calculated based on the dialog vector obtained through encoding the dialog text by a dialog processing module. Finally, the pre-trained question answering model is continued to be trained based on the dialog annotation alignment loss value, the image dialog loss value, and the image-text alignment loss value. In the embodiments, refer to the following Formula 2 as an exemplary training objective:

$${ℒ}_{stage}^{II} = {ℒ}_{icm} + {ℒ}_{tca} + {ℒ}_{mlm} \qquad Formula 2$$

For details of [symbol] ₘₗₘ, [symbol] _{tca}, and [symbol] _{icm}, refer to the following Formula 3 to Formula 5:

$${ℒ}_{mlm} = {\text{?}}_{( V , \hat{T} )} ∼ \{ {D}_{d} \} CE ( {y}_{mask} , {p}_{mask} ( V , \hat{T} ) ) \qquad Formula 3$$

$${ℒ}_{icm} = {\text{?}}_{( V , T , C ) ∼ {D}_{d}} CE ( {y}_{icm} , {p}_{icm} ( V , T , C ) ) \qquad Formula 4$$

$${ℒ}_{tca} = {‖ {H}_{L - F}^{t} - {H}_{L - F}^{c} ‖}_{2}^{2} \qquad Formula 5$$

$${ℒ}_{stage}^{II}$$

indicates a loss value at the second stage, D_{d} indicates dialog multi-modality data, \hat{T} indicates a masked character, y* indicates a correct value, and

$${H}_{L - F}^{*}$$

indicates and intermediate representation of L-F layers of a model.

Further, before the pre-trained question answering model is trained, a stage of training the initial question answering model, that is, the first stage, is further contained, so that the initial question answering model has a capability of matching an image and text. Specifically, before the obtaining a pre-training sample, the method further includes the following steps.

An initial training sample is obtained, where the initial training sample includes an image to be trained and an image annotation text corresponding to the image to be trained.

For the image to be trained, image processing is performed on the image to be trained by using the initial question answering model, to obtain an image vector.

For the image annotation text corresponding to the image to be trained, text processing is performed on the image annotation text by using the initial question answering model, to obtain a text annotation vector.

A predicted image description text is determined based on the image vector and the text annotation vector; and training the initial question answering model based on the predicted image description text.

During actual application, the initial training sample is obtained, and the initial question answering model is trained based on the initial training sample. Specifically, the image to be trained in the initial training sample is input into an image processing layer (FFN) in the initial question answering model, to obtain the image vector. Then, the image annotation text in the initial training sample is inputted into an image annotation layer (FFN) in the initial question answering model, to obtain the text annotation vector. Further, the predicted image description text is determined based on the image vector and the text annotation vector, so that the model learns a matching capability between an image and text. Then, the initial question answering model is trained based on the predicted image description text. It should be noted that the image annotation text is understood as manually annotated image annotation information of the image to be trained, or is understood as being implemented by using a basic image annotation model. This is not limited in the embodiments.

Further, the embodiments further provide a manner of determining a loss value based on the predicted image description text, to train the initial question answering model. Specifically, an operation of training the initial question answering model based on the predicted image description text includes the following steps.

An image-text annotation loss value is calculated based on the image vector and the text annotation vector.

An image-text alignment loss value is calculated based on the predicted image description text.

The initial question answering model is trained based on the image-text annotation loss value and the image-text alignment loss value.

During actual application, after respectively encoding the image and the text, the image processing module and an image annotation module in the initial question answering model further respectively calculates the image-text annotation loss value and the image-text alignment loss value, and further, the initial question answering model is trained based on the image-text annotation loss value and the image-text alignment loss value. In the embodiments, refer to the following training objectives:

$${ℒ}_{stage}^{I} = {ℒ}_{itm} + {ℒ}_{mlm} \qquad Formula 6$$

$${ℒ}_{mlm} = {\text{?}}_{( V , \hat{T} )} ∼ \{ {D}_{n} \} CE ( {y}_{mask} , {p}_{mask} ( V , \hat{T} ) ) \qquad Formula 7$$

$${ℒ}_{itm} = {\text{?}}_{( V , T ) ∼ {D}_{n}} CE ( {y}_{itm} , {p}_{itm} ( V , T ) ) \qquad Formula 8$$

$${ℒ}_{stage}^{I}$$

indicates a loss value at the first stage, Dₙ indicates non-dialog multi-modality data (image description text), and CE indicates cross entropy calculation.

Based on this, at the first stage of training the question answering model, the initial question answering model is trained by calculating the image-text annotation loss value and the image-text alignment loss value, so that a matching capability of multi-modality data between the dialog text and the image of the question answering model is continued to be trained based on the initial question answering model, to improve a capability of processing multi-modality data by the question answering model.

In addition, after obtaining the question answering model through the three stages, the executed object sends the answer information output by the question answering model for the question information to the user, to obtain a feedback result of the user for the answer information, so as to implement a fine-tuning process for the question answering model. Specifically, after the obtaining answer information corresponding to the question information, the method further includes the following steps.

The answer information is sent to the user.

The feedback result of the user for the answer information is received.

Model parameters in the question answering model is adjusted based on the feedback result.

During actual application, the executed object sends the answer information to the user. After receiving the answer information, the user provides feedback or evaluation based on specific content of the answer information, and sends the feedback result to the executed object. The executed object performs fine-tuning on the model parameters in the question answering model based on the received feedback result, to obtain the question answering model with a better application effect.

In conclusion, according to the question answering method provided in the embodiments, the question answering model is used for completing answer of the question information. The three-stage training process is further used in the training process of the question answering model, so that the question answering model continuously learns the capability of matching the image with the text, the capability of matching the image with the dialog, and an answer generation capability. In a specific training process, an incremental mixture-of-experts network is used for training processing modules in the question answering model, and a dialog modeling capability of multi-modality dialog data is introduced, to enhance a model step by step.

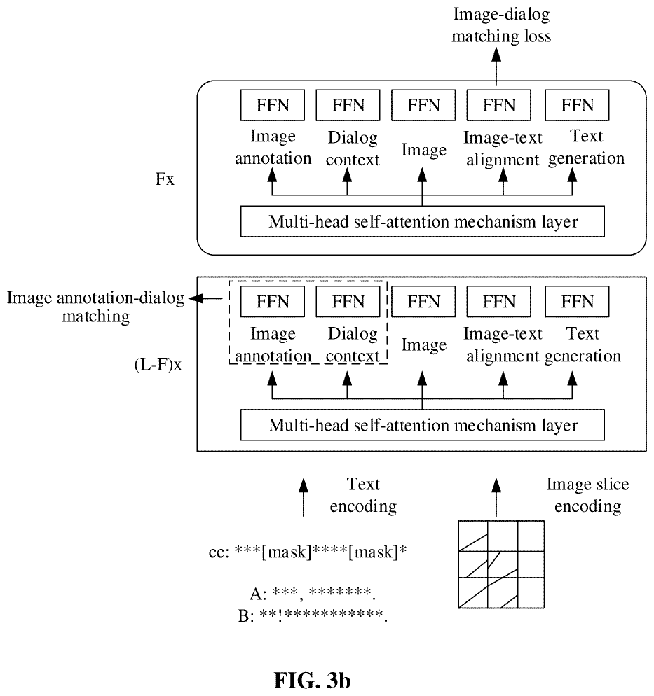

FIG. 3a, FIG. 3b, and FIG. 3c are respectively schematic diagrams of training a question answering model at different stages in a question answering method according to some embodiments of the present disclosure.

It should be noted that at each stage of training, the question answering model includes an L-layer structure, and each layer may include five different expert networks, which are respectively five network layers: image annotation, dialog context, image, image-text alignment, and text generation. In addition, each layer further has a shared multi-head self-attention mechanism layer.

FIG. 3a is a schematic diagram of first-stage training of a question answering model in a question answering method according to some embodiments of the present disclosure.

During actual application, in a first-stage pre-training process in FIG. 3a, an image and an image annotation text are respectively encoded and input into a subsequent L-F layer, to complete matching between the image annotation text and the image. Further, first-stage pre-training of the question answering model is implemented at an F layer by using the image-text alignment network.

FIG. 3b is a schematic diagram of second-stage training of a question answering model in a question answering method according to some embodiments of the present disclosure.

During actual application, in a second-stage pre-training process in FIG. 3b, inputs of the model are an image, an image annotation text, and a dialog text, which are first input into an L-F layer, to achieve a matching capability between the image annotation text and the dialog text. After a target semantic text is obtained, the target semantic text is then input into an F layer of the model, to match with the image, and complete a training process of image-text alignment.

FIG. 3c is a schematic diagram of third-stage training of a question answering model in a question answering method according to some embodiments of the present disclosure.

During actual application, in a third-stage pre-training process in FIG. 3c, inputs of the model is a dialog text and an image. In the training at the first two stages, the question answering model already has a capability of matching a dialog with an image. Further, in the third-stage pre-training, two networks of dialog context and image at an L-F layer are used for matching and understanding between the dialog and the image. Further, at an F layer of the model, a text generation network is trained, to train an answer information generation capability of the question answering model.

It should be noted that when used in a multi-modality dialog task, the question answering model includes multiple types of execution tasks. Task 1, a multi-modality intention recognition task, specifically, predicting whether image sharing needs to be performed in a current round. Task 2, a multi-modality retrieval task, retrieving an appropriate image and text based on a dialog history for answers. Task 3, a multi-modality dialog tracking task, tracking a key dialog requirement of a user. Task 4, a multi-modality text generation task, generating an appropriate answer based on a dialog history.

Based on this, in the process of training the question answering model provided in the embodiments, each layer of the model is divided into multiple expert networks, and different expert networks are combined when a specific task is completed, to perform task processing. Due to division of small modules, training of the model becomes more controllable, and interpretability of the model is also enhanced. In addition, parameters of an expert network that is not used in the specific task is not activated. This can greatly accelerate an inference speed of the model and improve parameter utilization. In addition, different semantic knowledge are endowed to the expert networks, so that the model ensures that a flow of each modality and data type is traceable, and interpretability and generalization capabilities of the model are enhanced.

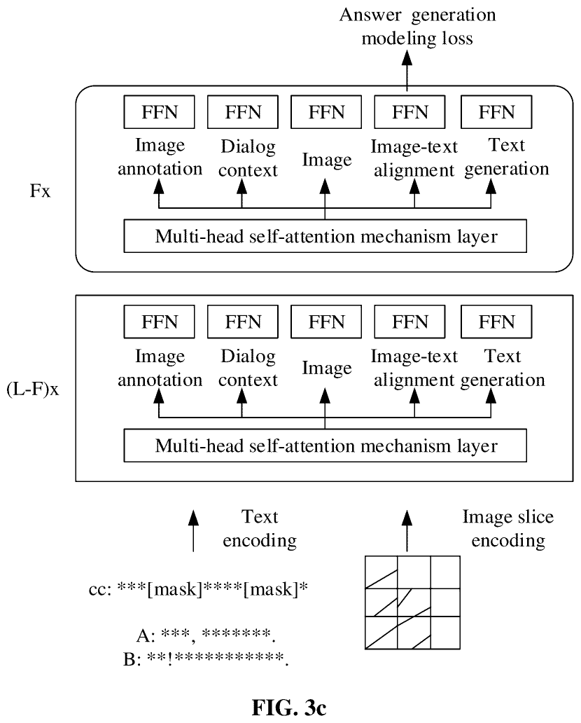

FIG. 4 is a flowchart of another question answering method according to some embodiments of the present disclosure. The method specifically includes the following steps.

It should be noted that the question answering method provided in the embodiments is applied to a cloud side device. To be specific, after receiving question information of a terminal side device, the question information is answered by using a question answering model of the cloud side device.

In step 402, a question answering request sent by the terminal side device is received, where the question answering request carries question information.

During actual application, the cloud side device receives the question answering request sent by the terminal side device, and obtains the question information carried in the question answering request. It should be noted that specific content and a form of the question information are not limited in the embodiments.

In step 404, the question information is inputted into the question answering model, to obtain answer information corresponding to the question information.

The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model. The target semantic information is generated based on an image description text corresponding to the image to be trained and a dialog text associated with the image to be trained.

During actual application, the cloud side device inputs the question information into the question answering model, and obtain the answer information output by the question answering model. For a training process of the question answering model in the cloud side device, refer to the training process described in the foregoing embodiment, that is, the three-stage question answering model training. Details are not described herein again.

In step 406, the answer information is sent to the terminal side device.

Further, after obtaining the answer information, the cloud side device feeds back the answer information to the terminal side device.

Based on this, the embodiments provide the question answering method applied to the cloud side device, so that a question response can be performed on the question information sent by the terminal side device. In addition, the question answering model is trained in the cloud side device, so that calculation resources and storage space of the terminal side device can be saved, and a better use effect can be provided for a user.

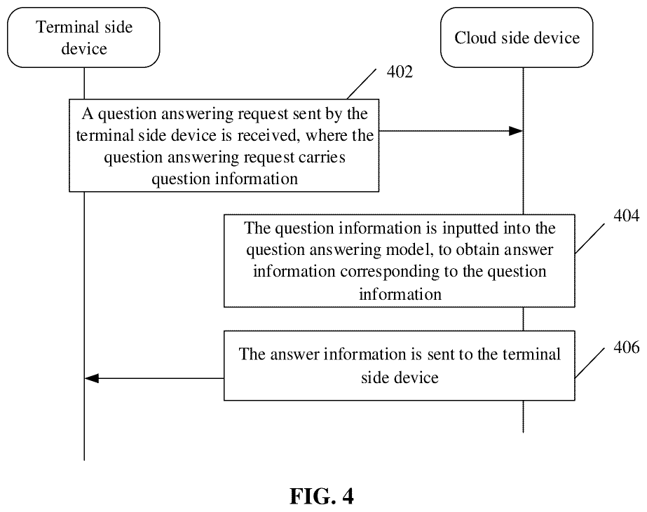

FIG. 5 is a flowchart of a question answering model training method according to some embodiments of the present disclosure. The method specifically includes the following steps.

It should be noted that the question answering model training method provided in the embodiments is applied to a terminal side device, or is applied to a cloud side device. This is not limited in the embodiments.

In step 502, a pre-training sample is obtained, where the pre-training sample includes an image to be trained, an image description text corresponding to the image to be trained, and a dialog text associated with the image to be trained.

In step 504, the pre-trained question answering model is trained based on a predicted image-text matching result corresponding to the pre-training sample, where the predicted image-text matching result is obtained by matching the image to be trained with target semantic information using the pre-trained question answering model, and the target semantic information is generated based on the image description text and the dialog text.

In step 506, a question sample is obtained, where the question sample includes an image to be trained and dialog text associated with the image to be trained.

In step 508, the question sample is inputted into the pre-trained question answering model, to output the predicted answer information, and train the pre-trained question answering model based on the predicted answer information, to obtain the question answering model.

In step 510, model parameters of the question answering model are sent to the terminal side device.

The pre-training sample is understood as sample data for training the pre-trained question answering model, and includes the image to be trained, the image description text corresponding to the image to be trained, and the dialog text associated with the image to be trained. The image to be trained is understood as any type of training image, and an image type is not limited. The image description text corresponding to the image to be trained is understood as text information that describes image content in the image to be trained, for example, describes object content and a state in the image. The dialog text associated with the image to be trained is understood as dialog information related to the image to be trained. The dialog information is understood as dialog data between different entities, and a form of dialog content and a dialog entity are not limited in the embodiments.

During actual application, the pre-trained question answering model is trained based on the predicted image-text matching result corresponding to the pre-training sample. The predicted image-text matching result is obtained by matching the image to be trained with the target semantic information based on an information matching layer (FFN) in the pre-trained question answering model. It should be noted that the target semantic information is understood as being obtained through vector matching between the image description text and the dialog text. In other words, this is understood as that the pre-trained question answering model can better understand semantic information in the dialog text based on the image description text. Further, after training of the pre-trained question answering model is completed, the question sample is further obtained. The question sample is understood as a training sample used in the question answering model, including the image to be trained and the dialog text associated with the image to be trained. The question sample is inputted into the pre-trained question answering model, to obtain the predicted answer information output by an information generation layer (FFN) in the pre-trained question answering model. Then, the pre-trained question answering model is continued to be trained based on the predicted answer information. Finally, the better-trained question answering model is obtained. The model parameters in the question answering model are sent to the terminal side device, so that the terminal side device can construct, based on the model parameters, the question answering model with a better use effect, thereby improving the use effect of the question answering model in the terminal side device.

Based on this, a pre-trained question answering model matching dialog text with an image can be trained. Further, the pre-trained question answering model can be trained to implement image-text alignment of the dialog text and the image, so that the answer information is generated and responded. The question answering model trains a dialog generation capability by using multi-modality data, enabling the question answering model to provide a better answer.

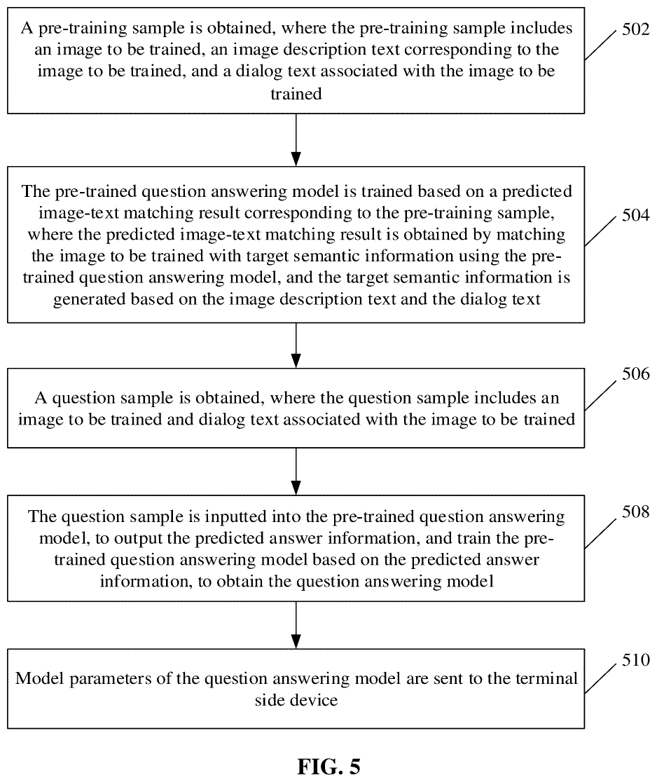

FIG. 6 is a flowchart of a textual question answering method according to some embodiments of the present disclosure. The method specifically includes the following steps.

It should be noted that for ease of understanding, the textual question answering method provided in the embodiments is applied to an application scenario of an intelligent customer service. A textual answer is provided for a textual question of a user. Automatic response text of the intelligent customer service is an output response of a question answering model.

In step 602, textual question information is received.

The textual question information is understood as a textual question raised by the user to the intelligent customer service, and the textual question is associated with an item on a platform on which the intelligent customer service is currently located. This is not limited in the embodiments.

In step 604, the textual question information is inputted into the question answering model, to obtain textual answer information corresponding to the textual question information.

During actual application, after the textual question information is inputted into the question answering model, the question answering model outputs the textual answer information corresponding to the textual question information. This is understood as that the intelligent customer service provides a textual answer for the textual question raised by the user. It should be noted that the question answering model provided in the embodiments is obtained with reference to the training method described in the foregoing embodiment, and details are not described herein. The question answering model includes a question answering model trained by using a cloud side device.

In addition, the embodiments further provide a scenario in which the question answering model is trained on a terminal side device, and is used in the terminal side device. Specifically, before inputting the textual question information into the question answering model, to obtain the textual answer information corresponding to the textual question information, the method further includes the following steps.

Model parameters of the question answering model are obtained in the cloud side device.

A textual question sample is obtained.

A question answering model to be trained is constructed based on the model parameters, and the question answering model to be trained is trained based on the textual question sample, to obtain the question answering model.

During actual application, the terminal side device obtains the model parameters of the question answering model in the cloud side device. For a process of obtaining the model parameters, refer to the foregoing process of training the question answering model on the cloud side device, and details are not described herein. Further, the terminal side device further obtains the textual question sample, constructs the question answering model to be trained by using the model parameters of the question answering model obtained from the cloud side device, and then trains the question answering model to be trained based on the textual question sample in the terminal side device, to obtain the question answering model. Further, the question answering model trained in the terminal side device is locally applied.

It should be noted that for a process of training the model parameters of the question answering model in the cloud side device, refer to descriptions of training the question answering model in the foregoing embodiment, that is, a process of the three-stage question answering model training, and details are not described herein.

In step 606, the textual answer information is displayed.

During actual application, after answering to the textual question information by using the question answering model, the terminal side device displays the textual answer information on a display interface of the terminal side device.

In conclusion, according to the textual question answering method provided in the embodiments, the question answering model is used for automatically answering to the textual question information, and the question answering model is the question answering model trained in the cloud side device, or is the question model trained in the terminal side device. These question answering models can all provide a fast and reasonable answer to the textual question information, thereby improving a use effect of the user for the textual answer.

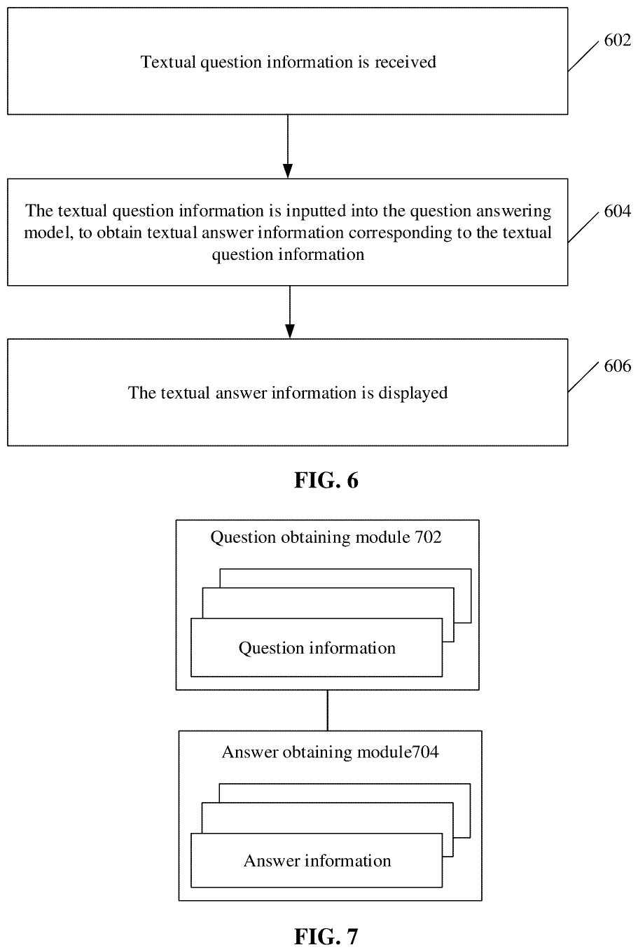

Corresponding to the foregoing method embodiments, some embodiments of the present disclosure further provide a question answering apparatus. FIG. 7 is a structural schematic diagram of a question answering apparatus according to some embodiments of the present disclosure. As shown in FIG. 7, the apparatus includes:
a question obtaining module 702, configured to obtain question information to be answered; and
an answer obtaining module 704, configured to input the question information into a question answering model, to obtain answer information corresponding to the question information. The question answering model is trained based on predicted answer information. The predicted answer information is obtained by predicting, by using a pre-trained question answering model, answer information corresponding to a question sample. The pre-trained question answering model is trained based on a predicted image-text matching result. The predicted image-text matching result is obtained by matching an image to be trained with target semantic information using the pre-trained question answering model. The target semantic information is generated based on an image description text corresponding to the image to be trained and a dialog text associated with the image to be trained.

Optionally, the apparatus further includes:
a question answering model training module, configured to: obtain a pre-training sample, where the pre-training sample includes an image to be trained, an image description text corresponding to the image to be trained, and a dialog text associated with the image to be trained;
train the pre-trained question answering model based on the predicted image-text matching result corresponding to the pre-training sample, where the predicted image-text matching result is obtained by matching the image to be trained with the target semantic information using the pre-trained question answering model, and the target semantic information is generated based on the image description text and the dialog text;
obtain a question sample, where the question sample includes an image to be trained and dialog text associated with the image to be trained; and
input the question sample to the pre-trained question answering model, to output the predicted answer information, and train the pre-trained question answering model based on the predicted answer information, to obtain the question answering model.

Optionally, the question answering model training module is further configured to:
calculate an autoregressive loss value based on the predicted answer information; and train the pre-trained question answering model based on the autoregressive loss value, to obtain the question answering model.

Optionally, the question answering model training module is further configured to:
perform, for the image to be trained in the pre-training sample, image processing on the image to be trained by using the pre-trained question answering model, to obtain an image vector;
perform, for the dialog text in the pre-training sample and associated with the image to be trained, text processing on the dialog text by using the pre-trained question answering model, to obtain a dialog vector;
generate the predicted image-text matching result based on the image vector and the dialog vector; and
determine an image-text alignment loss value based on the predicted image-text matching result, and train the pre-trained question answering model based on the image-text alignment loss value.

Optionally, the question answering model training module is further configured to:
calculate a dialog annotation alignment loss value based on the image vector, and calculate an image dialog loss value based on the dialog vector; and
train the pre-trained question answering model based on the dialog annotation alignment loss value, the image dialog loss value, and the image-text alignment loss value.

Optionally, the question answering model training module is further configured to:
obtain an initial training sample, where the initial training sample includes an image to be trained and an image annotation text corresponding to the image to be trained;
perform, for the image to be trained, image processing on the image to be trained by using an initial question answering model, to obtain an image vector;
perform, for the image annotation text corresponding to the image to be trained, text processing on the image annotation text by using the initial question answering model, to obtain a text annotation vector;
determine a predicted image description text based on the image vector and the text annotation vector; and
train the initial question answering model based on the predicted image description text.

Optionally, the question answering model training module is further configured to:
calculate an image-text annotation loss value based on the image vector and the text annotation vector;
calculate an image-text alignment loss value based on the predicted image description text; and
train the initial question answering model based on the image-text annotation loss value and the image-text alignment loss value.

Optionally, the apparatus further includes:
a model adjustment module, configured to: send the answer information to a user;
receive a feedback result of the user for the answer information; and
adjust model parameters in the question answering model based on the feedback result.

In conclusion, according to the question answering apparatus provided in the embodiments of the present disclosure, the question information to be answered is inputted into the question answering model, to obtain the answer information output by the question answering model. The question answering model is obtained by training the pre-trained question answering model. The answer information corresponding to the question sample is predicted by using the pre-trained question answering model, and the question answering model is trained based on the predicted answer information. In addition, the pre-trained question answering model is trained based on the predicted image-text matching result, and the predicted image-text matching result is obtained by matching the image to be trained with the target semantic information by the pre-trained question answering model. In addition, the target semantic information is generated based on the image description text corresponding to the image to be trained and the dialog text associated with the image to be trained. In this manner, an objective of training the question answering model to better learn target semantic text by using a limited amount of dialog texts and images to be trained, so that the question answering model can be trained to output dialog content based on the dialog text. In this way, a large amount of dialog texts does not need to be used as training data, and the question answering model can better learn semantic knowledge in the dialog text, so that answer information of the trained question answering model is more accurate, thereby improving an application effect of the model.

The foregoing is a schematic solution of the question answering apparatus in the embodiments. It should be noted that the technical solutions of the question answering apparatus and the technical solutions of the foregoing question answering method are of the same concept. For details that are not described in detail in the technical solution of the question answering apparatus, refer to the descriptions of the technical solutions of the foregoing question answering method.

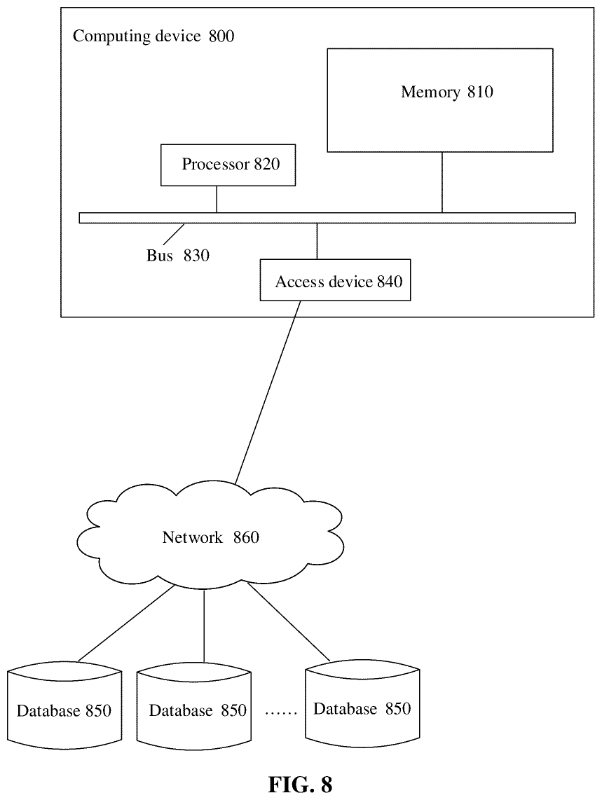

FIG. 8 is a structural block diagram of a computing device 800 according to some embodiments of the present disclosure. Components of the computing device 800 include but are not limited to a memory 810 and a processor 820. The processor 820 is connected with the memory 810 via a bus 830, and a database 850 is configured to store data.

The computing device 800 further includes an access device 840, and the access device 840 enables the computing device 800 to perform communication over at least one network 860. For example, the at least one network includes a public switched telephone network (PSTN), a local area network (LAN), a wide area network (WAN), a personal area network (PAN), or a combination of communication networks such as an Internet. The access device 840 includes at least one of any type of wired or wireless network interface (for example, a network interface card (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and near field communication (NFC).

In some embodiments of the present disclosure, the foregoing components of the computing device 800 and other components not shown in FIG. 8 is connected with each other, for example, via a bus. It should be understood that the structural block diagram of the computing device shown in FIG. 8 is used for exemplary purposes, and is not intended to limit the scope of the present disclosure. A person having ordinary skill in the art may add or replace with other components as required.

The computing device 800 is any type of static or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses) or another type of mobile device, or a static computing device, for example, a desktop computer or a personal computer (PC). The computing device 800 may alternatively be a mobile or static server.

The processor 820 is configured to execute the following computer-executable instructions. When the computer-executable instructions are executed by the processor, the steps in the foregoing question answering method, question answering model training method, and textual question answering method are implemented.

The foregoing is a schematic solution of the computing device in the embodiments. It should be noted that the technical solutions of the computing device and the technical solutions of the foregoing question answering method, question answering model training method, and textual question answering method are of the same concept. For details that are not described in detail in the technical solutions of the computing device, refer to the descriptions of the technical solutions of the foregoing question answering method, question answering model training method, and textual question answering method.

Some embodiments of the present disclosure further provide a computer-readable storage medium, storing computer-executable instructions. When the computer-executable instructions are executed by a processor, the steps in the foregoing question answering method, question answering model training method, and textual question answering method are implemented.

The foregoing is a schematic solution of the computer-readable storage medium in the embodiments. It should be noted that the technical solutions of the storage medium and the technical solutions of the foregoing question answering method, question answering model training method, and textual question answering method are of the same concept. For details that are not described in detail in the technical solutions of the storage medium, refer to the descriptions of the technical solutions of the foregoing question answering method, question answering model training method, and textual question answering method.

Some embodiments of the present disclosure further provide a computer program. When the computer program is executed in a computer, the computer is enabled to perform the steps in the foregoing question answering method, question answering model training method, and textual question answering method.

The foregoing is a schematic solution of the computer program in the embodiments. It should be noted that the technical solutions of the computer program and the technical solutions of the foregoing question answering method, question answering model training method, and textual question answering method are of the same concept. For details that are not described in detail in the technical solutions of the computer program, refer to the descriptions of the technical solutions of the foregoing question answering method, question answering model training method, and textual question answering method.

The foregoing describes specific embodiments of the present disclosure. Other embodiments fall within the scope of the appended claims. In some cases, the actions or steps recorded in the claims are performed in sequences different from those in embodiments and an expected result may still be achieved. In addition, the processes depicted in the accompanying drawings are not necessarily performed in the specific order or successively to achieve an expected result. In some implementations, multitasking and parallel processing are feasible or beneficial.

Computer instructions include computer program codes. The computer program codes are in a source code form, an object code form, an executable file form, some intermediate forms, or the like. A computer-readable medium may include: any entity or apparatus that can carry the computer program code, a record medium, a USB flash drive, a removable hard disk drive, a magnetic disk, an optical disc, a computer memory, a read-only memory (ROM), a random access memory (RAM), an electric carrier signal, a telecommunication signal, a software distribution medium, and the like. It should be noted that content included in the computer-readable medium is properly increased or reduced based on requirements of patent practices. For example, in some regions, based on patent practices, the computer-readable medium does not include an electric carrier signal and a telecommunication signal.

It should be noted that, for each of the foregoing method embodiments, for ease of description, the method embodiments are described as a series of action combination. But a person having ordinary skill in the art is to know that embodiments of the present disclosure are not limited to any described sequence of the action, as some steps can use other sequences or can be performed simultaneously according to embodiments of the present disclosure. In addition, a person having ordinary skill in the art should also know that all embodiments described in the present disclosure are exemplary embodiments, and the related actions and modules are not necessarily mandatory to embodiments of the present disclosure.

In the foregoing embodiments, the descriptions of each embodiment has respective focuses. For a part that is not described in detail in some embodiments, refer to related descriptions in other embodiments.

The exemplary embodiments of the present disclosure disclosed above are used for helping explain the present disclosure. In optional embodiments, all details are not described in detail, and the present invention is not limited to specific implementations. Clearly, many modifications and variations can be made according to the content of embodiments of the present disclosure. In the present disclosure, these embodiments are selected and specifically described to better explain the principle and the practical application of embodiments of the present disclosure, so that a person having ordinary skill in the art can understand and use the present disclosure well. The present disclosure is limited by the claims along with the full scope and equivalents of the present disclosure.

### INDUSTRIAL APPLICABILITY

The method for training a text generation model, and a text generation method and apparatus provided in embodiments of the present disclosure are applied to a training text generation scenario. Question information to be answered is inputted into a question answering model, to obtain answer information output by the question answering model. The question answering model is obtained by training a pre-trained question answering model. Answer information corresponding to a question sample is predicted by using the pre-trained question answering model, and the question answering model is trained based on predicted answer information. In addition, the pre-trained question answering model is trained based on a predicted image-text matching result, and the predicted image-text matching result is obtained by matching an image to be trained with target semantic information by the pre-trained question answering model. In addition, the target semantic information is generated based on an image description text corresponding to the image to be trained and a dialog text associated with the image to be trained. In this manner, an objective of training the question answering model to better learn target semantic text by using a limited amount of dialog texts and images to be trained, so that the question answering model can be trained to output dialog content based on the dialog text. In this way, a large amount of dialog texts does not need to be used as training data, and the question answering model can better learn semantic knowledge in the dialog text, so that answer information of the trained question answering model is more accurate, thereby improving an application effect of the model.

1. A question answering method, comprising:
obtaining question information to be answered; and
inputting the question information into a question answering model, to obtain answer information corresponding to the question information;
wherein the question answering model is trained based on predicted answer information, the predicted answer information is obtained by predicting, by using a pre-trained question answering model, answer information corresponding to a question sample, the pre-trained question answering model is trained based on a predicted image-text matching result, the predicted image-text matching result is obtained by matching an image to be trained with target semantic information using the pre-trained question answering model, and the target semantic information is generated based on an image description text corresponding to the image to be trained and a dialog text associated with the image to be trained.

2. The question answering method according to claim 1, wherein before inputting the question information into the question answering model, to obtain the answer information corresponding to the question information, the question answering method further comprises:
obtaining a pre-training sample, wherein the pre-training sample comprises an image to be trained, an image description text corresponding to the image to be trained, and a dialog text associated with the image to be trained;
training the pre-trained question answering model based on the predicted image-text matching result corresponding to the pre-training sample;
obtaining a question sample, wherein the question sample comprises an image to be trained and the dialog text associated with the image to be trained; and
inputting the question sample into the pre-trained question answering model, to output the predicted answer information, and training the pre-trained question answering model based on the predicted answer information, to obtain the question answering model.

3. The question answering method according to claim 2, wherein training the pre-trained question answering model based on the predicted answer information, to obtain the question answering model comprises:
calculating an autoregressive loss value based on the predicted answer information; and
training the pre-trained question answering model based on the autoregressive loss value, to obtain the question answering model.

4. The question answering method according to claim 2, wherein training the pre-trained question answering model based on the predicted image-text matching result corresponding to the pre-training sample comprises:
performing, for the image to be trained in the pre-training sample, image processing on the image to be trained by using the pre-trained question answering model, to obtain an image vector;
performing, for the dialog text in the pre-training sample and associated with the image to be trained, text processing on the dialog text by using the pre-trained question answering model, to obtain a dialog vector;
generating the predicted image-text matching result based on the image vector and the dialog vector; and
determining an image-text alignment loss value based on the predicted image-text matching result, and training the pre-trained question answering model based on the image-text alignment loss value.

5. The question answering method according to claim 4, wherein training the pre-trained question answering model based on the image-text alignment loss value comprises:
calculating a dialog annotation alignment loss value based on the image vector, and calculating an image dialog loss value based on the dialog vector; and
training the pre-trained question answering model based on the dialog annotation alignment loss value, the image dialog loss value, and the image-text alignment loss value.

6. The question answering method according to claim 2, wherein before obtaining the pre-training sample, the method further comprises:
obtaining an initial training sample, wherein the initial training sample comprises the image to be trained and an image annotation text corresponding to the image to be trained;
performing, for the image to be trained in the initial training sample, image processing on the image to be trained by using an initial question answering model, to obtain an image vector;
performing, for the image annotation text corresponding to the image to be trained in the initial training sample, text processing on the image annotation text by using the initial question answering model, to obtain a text annotation vector;
determining a predicted image description text based on the image vector and the text annotation vector; and training the initial question answering model based on the predicted image description text.

7. The question answering method according to claim 6, wherein training the initial question answering model based on the predicted image description text comprises:
calculating an image-text annotation loss value based on the image vector and the text annotation vector;
calculating an image-text alignment loss value based on the predicted image description text; and
training the initial question answering model based on the image-text annotation loss value and the image-text alignment loss value.

8. The question answering method according to claim 1, wherein after obtaining the answer information corresponding to the question information, the method further comprises:
sending the answer information to a user;
receiving a feedback result of the user for the answer information; and
adjusting model parameters in the question answering model based on the feedback result.

9. A question answering method, applied to a cloud side device, wherein the question answering method comprises:
receiving a question answering request sent by a terminal side device, wherein the question answering request carries question information;
inputting the question information into a question answering model, to obtain answer information corresponding to the question information;
wherein the question answering model is trained based on predicted answer information, the predicted answer information is obtained by predicting, by using a pre-trained question answering model, answer information corresponding to a question sample, the pre-trained question answering model is trained based on a predicted image-text matching result, the predicted image-text matching result is obtained by matching an image to be trained with target semantic information using the pre-trained question answering model, and the target semantic information is generated based on an image description text corresponding to the image to be trained and a dialog text associated with the image to be trained; and
sending the answer information corresponding to the question information to the terminal side device.

10. (canceled)

11. (canceled)

12. (canceled)

13. A computing device, comprising:
a memory and a processor;
wherein the memory is configured to store computer-executable instructions, the processor is configured to execute the computer-executable instructions, and when the computer-executable instructions are executed by the processor, the following steps are implemented:
obtaining question information to be answered; and
inputting the question information into a question answering model, to obtain answer information corresponding to the question information;
wherein the question answering model is trained based on predicted answer information, the predicted answer information is obtained by predicting, by using a pre-trained question answering model, answer information corresponding to a question sample, the pre-trained question answering model is trained based on a predicted image-text matching result, the predicted image-text matching result is obtained by matching an image to be trained with target semantic information using the pre-trained question answering model, and the target semantic information is generated based on an image description text corresponding to the image to be trained and a dialog text associated with the image to be trained.

14. (canceled)

15. The question answering method according to claim 3, wherein training the pre-trained question answering model based on the predicted image-text matching result corresponding to the pre-training sample comprises:
performing, for the image to be trained in the pre-training sample, image processing on the image to be trained by using the pre-trained question answering model, to obtain an image vector;
performing, for the dialog text in the pre-training sample and associated with the image to be trained, text processing on the dialog text by using the pre-trained question answering model, to obtain a dialog vector;
generating the predicted image-text matching result based on the image vector and the dialog vector; and
determining an image-text alignment loss value based on the predicted image-text matching result, and training the pre-trained question answering model based on the image-text alignment loss value.

16. The question answering method according to claim 1, wherein the predicted image-text matching result is obtained by matching the image to be trained with the target semantic information based on an information matching layer in the pre-trained question answering model.

17. The question answering method according to claim 1, wherein the target semantic information is obtained through vector matching between the image description text and the dialog text.

18. The question answering method according to claim 4, wherein performing image processing on the image to be trained by using the pre-trained question answering model, to obtain the image vector comprises:
performing image processing on the image to be trained by using an image processing layer in the pre-trained question answering model, to obtain the image vector.

19. The question answering method according to claim 4, wherein performing text processing on the dialog text by using the pre-trained question answering model, to obtain the dialog vector comprises:
performing text processing on the dialog text by using a dialog processing layer in the pre-trained question answering model, to obtain the dialog vector.

20. The question answering method according to claim 4, wherein determining the image-text alignment loss value based on the predicted image-text matching result comprises:
determining a loss value of the image-text alignment layer based on the predicted image-text matching result.

21. The question answering method according to claim 6, wherein performing image processing on the image to be trained by using the initial question answering model, to obtain the image vector comprises:
inputting the image to be trained in the initial training sample into an image processing layer in the initial question answering model, to obtain the image vector.

22. The question answering method according to claim 6, wherein performing text processing on the image annotation text by using the initial question answering model, to obtain the text annotation vector comprises:
inputting the image annotation text in the initial training sample into an image annotation layer in the initial question answering model, to obtain the text annotation vector.

23. The question answering method according to claim 1, wherein during the process of training the question answering model, each layer of the question answering model is divided into multiple expert networks, and different expert networks are combined when a specific task is completed.

24. The question answering method according to claim 23, wherein a plurality of types of the specific task comprise: a multi-modality intention recognition task, a multi-modality retrieval task, a multi-modality dialog tracking task, and a multi-modality text generation task.
